(19) United States
(12) Patent Application Publication
(10) Pub. No.: US 2010/0208011 A1
(43) Pub. Date: Aug. 19, 2010

(54) Recording Head and Image Forming Apparatus

(75) Inventor: Sho Onozawa, Kanagawa (JP)

Correspondence Address: FISH & RICHARDSON P.C., PO BOX 1022, MINNEAPOLIS, MN, 55440-1022, US

(73) Assignee: FUJIFILM Corporation

(21) Appl. No.: 12/707,565

(22) Filed: Feb. 17, 2010

(30) Foreign Application Priority Data
Feb. 18, 2009 (JP) 2009035395

(51) Int. Cl. B41J 2/175

(52) U.S. Cl. 347/85

(57) ABSTRACT

There is provided a recording head including: plural pressure chambers that are filled with a liquid and are in communication with nozzles that eject liquid droplets toward a recording medium; a driving section that changes pressure in the pressure chamber and ejects a liquid droplet from the nozzle; a first common path that is connected to plural liquid supply paths that are in communication with the respective pressure chambers, the first common path storing the liquid for supply to the pressure chambers; a second common path that is superimposed on the first common path, is in communication with the first common path, and stores the liquid.

### CROSS-REFERENCE TO RELATED APPLICATION

This application claims priority under 35 USC 119 from Japanese Patent Application No. 2009-035395 filed on Feb. 18, 2009, the disclosure of which is incorporated by reference herein.

### BACKGROUND

1. Technical Field

The present invention relates to a recording head and an image forming apparatus.

2. Related Art

In a single-pass inkjet recording apparatus, since the desired image resolution must be realized when only passing a recording medium a single time, the number of nozzles of an inkjet recording head in the slow scanning direction necessarily become large. Due to this increase, the length of a common path storing a liquid (ink or the like) gets longer, lowering the resonance frequency of the liquid in the common path. When this resonance frequency is lowered to the vicinity of the ejection frequencies, the liquid droplets ejection characteristics between the nozzles are influenced by resonance in the common path, with so-called cross-talk becoming significant, potentially leading to a deterioration in the quality of images formed. The cross-talk referred to here is a phenomenon that disrupts ink ejection, as the ejection operation at a given nozzle interferes with the ink at another nozzle.

A configuration is described in Japanese Patent Application Laid-Open (JP-A) No. 2006-82394 in which an air chamber is provided at a position in the vicinity of a common path, and a thin plate, capable of resilient deformation, is employed between the common path and the air chamber so as to partition therebetween. The acoustic capacitance of the common path is thereby made larger, with the aim of ensuring sufficient acoustic capacitance to attenuate cross-talk.

However, in JP-A No. 2006-82394, since the thin plate capable of resilient deformation partitions between the common path and the air chamber, defects, such as breakage, readily occur in the thin plate, and there is the possibility of liquid leaks occurring. Furthermore, while the capacitance damper due to the thin plate is effective for high frequency components, it cannot be said to be effective for low frequency components, and so when the resonance frequency of the liquid within the common path is lowered to the vicinity of the ejection frequencies, it is difficult to suppress the influence of cross-talk due to low frequency resonance.

### SUMMARY

A recording head according to a first aspect of the present invention includes: plural pressure chambers that are filled with a liquid and are in communication with nozzles that eject liquid droplets toward a recording medium; a driving section that changes pressure in the pressure chamber and ejects a liquid droplet from the nozzle; a first common path that is connected to plural liquid supply paths that are in communication with the respective pressure chambers, the first common path storing the liquid for supply to the pressure chambers; a second common path that is superimposed on the first common path, is in communication with the first common path, and stores the liquid.

According to the first aspect of the present invention, the plural liquid supply paths, in communication with the respective pressure chambers, are connected to the first common path for storing the liquid, and the liquid in the first common path is supplied to the respective pressure chambers through the plural liquid supply paths. A liquid droplet is ejected toward the recording medium from the nozzle that is in communication with the pressure chamber by changing the pressure in the pressure chamber with the driving section. The second common path is disposed superimposed on the first common path, the second common path is in communication with the first common path and stores the liquid. By so doing, the overall common path storing the liquid is made longer by provision of the first common path and the second common path, lowering the resonance frequency of the liquid in the common path, and the effective resonance frequency can be moved away from the ejection frequencies. Consequently, the influence of cross-talk due to low frequency resonance can be suppressed. Furthermore, since the overall common path storing the liquid is made longer, influence of cross-talk can be effectively suppressed by viscosity attenuation.

A second aspect of the present invention is the recording head of the first aspect, further including a divider plate that divides the first common path from the second common path, wherein the liquid is circulated between the first common path and the second common path through openings formed in the respective two ends of the divider plate.

According to the second aspect of the present invention, the liquid is circulated between the first common path and the second common path through the openings formed in the respective two ends of the divider plate that divides the first common path from the second common path. By so doing, since the path the liquid circulates in is made longer, influence due to cross-talk can be effectively suppressed. Furthermore, the first common path and the second common path can be effectively placed, and the liquid is prevented from dwelling in each of the common paths.

A third aspect of the present invention is the recording head of the second aspect, configured with a multi-layer structure in which one or plural common paths, as well as the second common path, is/are provided.

According to the third aspect of the present invention, configuration is made with a multi-layer structure in which one or plural common paths, as well as the second common path, is/are provided, and the path storing the liquid is made even longer by the provision of the one or plural common paths. By so doing, influence due to cross-talk can be effectively suppressed.

An image forming apparatus according to a fourth aspect of the present invention forms an image by passing a recording medium through a position facing a recording head, the image forming apparatus including: the recording head of any one of the first to the third aspects; and a conveying section that conveys a recording medium to a position facing the recording head.

According to the fourth aspect of the present invention, an image is formed by conveying a recording medium to a position facing one or other of the recording heads of the first to the third aspects using a conveying section, and passing the recording medium through the position facing the recording head. When this is performed, since configuration is made in which the overall common path storing the liquid is made longer by provision of the first common path and the second common path of the recording head, influence of cross-talk due to low frequency resonance is suppressed, and occurrences of a deterioration in image quality can be prevented or suppressed.

According to the present invention, the influence of cross-talk due to low frequency resonance can be suppressed, and image quality can be raised.

### BRIEF DESCRIPTION OF THE DRAWINGS

Exemplary embodiments of the present invention will be described in detail based on the following figures, wherein:

FIG. 1 is an overall configuration diagram showing a configuration of an image forming apparatus equipped with an inkjet line-head according to a first exemplary embodiment of the present invention;

FIG. 2 is a see-through perspective view showing a configuration of an inkjet line-head according to the first exemplary embodiment;

FIG. 3 is a schematic cross-section showing a cross-section along the length direction of an inkjet line-head according to the first exemplary embodiment;

FIG. 4A is a schematic plan view showing a configuration of a first common path of an inkjet line-head according to the first exemplary embodiment;

FIG. 4B is enlarged plan view diagram showing a portion of the configuration of the first common path;

FIG. 5 is a schematic cross-section showing a cross-section along a direction orthogonal to the length direction of an inkjet line-head according to the first exemplary embodiment; and

FIG. 6 is a schematic cross-section showing a cross-section along the length direction of an inkjet line-head according to a second exemplary embodiment.

### DETAILED DESCRIPTION

### First Exemplary Embodiment

Explanation will now be given of an image forming apparatus equipped with an inkjet line-head as a recording head according to a first exemplary embodiment of the present invention.

First, explanation will be given of the overall configuration of an image forming apparatus 10.

Image Forming Apparatus

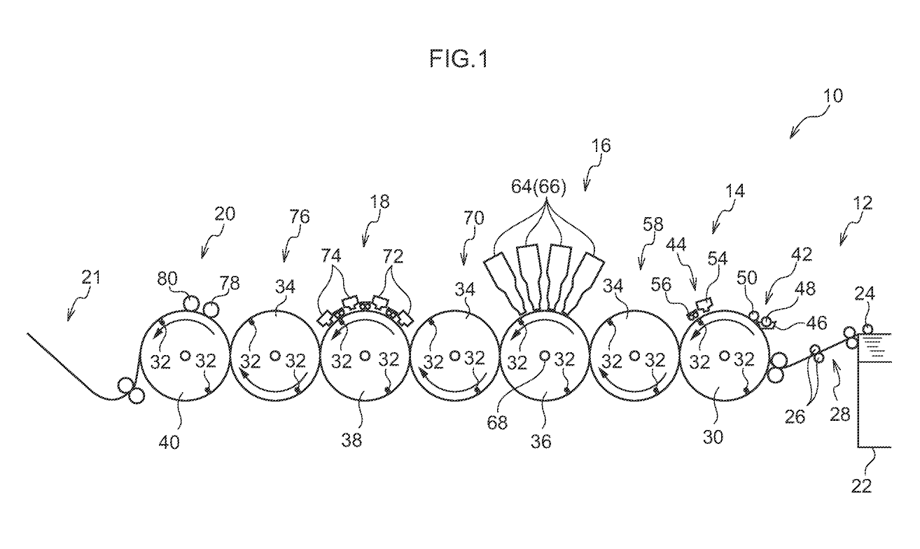

As shown in FIG. 1, the image forming apparatus 10 according to the present exemplary embodiment is provided, at the conveying direction upstream side of sheets of paper (referred to as “paper” below) serving as a recording medium, with a paper feed conveying section 12 that feeds and conveys paper. Provided at the downstream side of the paper feed conveying section 12 are, along the paper conveying direction: a processing liquid application section 14 that applies a processing liquid onto a recording face of the paper; an image forming section 16 that forms an image on the recording face of the paper; an ink drying section 18 that dries the image that has been formed on the recording face; an image fixing section 20 that fixes the dried image to the paper; and a discharge section 21 that discharges the paper to which the image has been fixed.

Explanation will now be given of each of the processing sections.

Paper Feed Conveying Section

In the paper feed conveying section 12 are provided a stacking section 22, in which paper is stacked, and, to the downstream side in the paper conveying direction (this is sometimes abbreviated below to “paper conveying direction”) of the stacking section 22, a feed section 24 that feeds out paper stacked in the stacking section 22, one sheet at a time. The paper fed out by the feed section 24 is conveyed toward the processing liquid application section 14 through a conveying section 28 configured by plural pairs of rollers 26.

Processing Liquid Application Section

A processing liquid application drum 30 is rotatably disposed in the processing liquid application section 14. Retaining members 32 are provided to the processing liquid application drum 30 for nipping the leading edge of the paper and retaining the paper. The paper is conveyed to the downstream side, with the paper in a retained state on the surface of the processing liquid application drum 30 due to the retaining members 32, by rotation of the processing liquid application drum 30.

Note that the retaining members 32 are also provided to an intermediate conveying drum 34, an image forming drum 36, an ink drying drum 38, and an image fixing drum 40 (described below) in a similar manner to provision to the processing liquid application drum 30. The paper is passed from a drum on the upstream side and received by a drum on the downstream side by use of the retaining members 32.

A processing liquid application device 42 and a processing liquid drying device 44 are disposed above the processing liquid application drum 30, around the circumferential direction of the processing liquid application drum 30. Processing liquid is applied to the recording face of the paper by the processing liquid application device 42, and this processing liquid is dried by the processing liquid drying device 44.

The processing liquid here reacts with ink, having the effect of aggregating colorants (pigments) and promoting separation of colorants (pigments) from their solvent medium. A reservoir section 46 is provided to the processing liquid application device 42, and processing liquid is stored in the reservoir section 46. A portion of a gravure roller 48 is steeped in the processing liquid.

A rubber roller 50 is disposed in pressing contact with the gravure roller 48, and the rubber roller 50 makes contact with the recording face (front face) side of the paper and applies processing liquid thereto. There is also a squeegee (not shown in the drawings) that makes contact with the gravure roller 48, and meters the processing liquid amount applied to the recording face of the paper.

Ideally the thickness of the processing liquid film is sufficiently smaller than the liquid droplets of the head ejected droplets. For example, when the amount of the ejected droplets is 2 pl, then the average diameter of the liquid droplets of the head ejected droplets is 15.6 μm, and if the thickness of the processing liquid film is thick then the ink dots do not make contact with the recording face of the paper, and float within the processing liquid. The processing liquid film thickness is preferably 3 μm or less, such that an impacting dot diameter of 30 μm or greater is obtained for a 2 pl ejected droplet amount.

However, in the processing liquid drying device 44, a heated air nozzle 54 and an infra-red heater 56 (referred to below as “IR heater 56”) are disposed in close proximity to the surface of the processing liquid application drum 30. The solvent medium in the processing liquid, such as water or the like, is evaporated by the heated air nozzle 54 and the IR heater 56, and a solid or thin film processing liquid layer is formed on the recording face side of the paper. By making the processing liquid into a thin layer by the processing liquid drying process, the dots of ink ejected droplets make contact with the paper surface in the image forming section 16, and the necessary dot size is obtained, reacting with the processing liquid formed in a thin layer, aggregating colorants, and the actions to immobilize the dots on the paper surface are readily obtained.

In this manner, the processing liquid is applied to the recording face in the processing liquid application section 14, and the dried paper is conveyed to an intermediate conveying section 58 provided between the processing liquid application section 14 and the image forming section 16.

Intermediate Conveying Section

In the intermediate conveying section 58, the intermediate conveying drum 34 is rotatably provided, the paper is retained on the surface of the intermediate conveying drum 34 by the retaining members 32 provided to the intermediate conveying drum 34, and the paper is conveyed toward the downstream side by rotation of the intermediate conveying drum 34.

Image Forming Section

In the image forming section 16, the image forming drum 36 is rotatably provided, the paper is retained on the surface of the image forming drum 36 by retaining members 32 provided to the image forming drum 36, and the paper is conveyed toward the downstream side by rotation of the image forming drum 36.

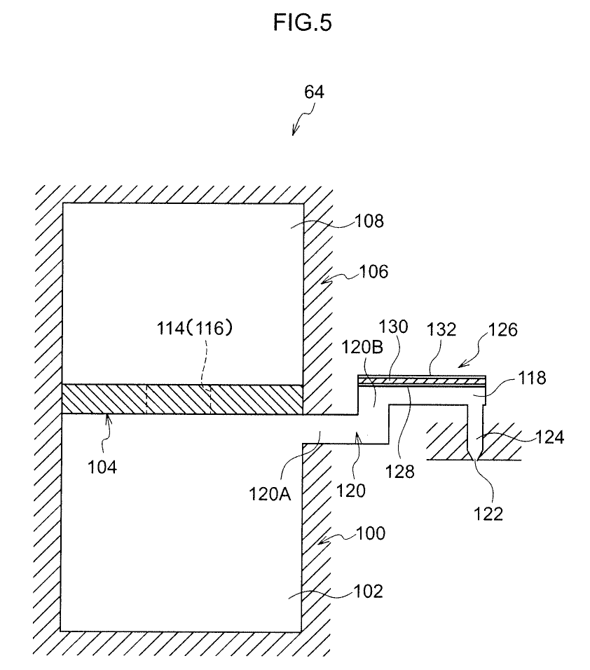

A head unit 66, configured with single-pass inkjet line-heads 64, is disposed above the image forming drum 36, in close proximity to the surface of the image forming drum 36. Inkjet line-heads 64, at least for the basic colors YMCK, are arrayed in the head unit 66 around the circumferential direction of the image forming drum 36, and images for each of the colors are formed on the processing liquid layer that was formed on the recording face of the paper in the processing liquid application section 14. The inkjet line-heads 64 each have a length corresponding to the maximum paper width applicable to the image forming apparatus 10, and plural nozzles 122 for ink ejection (see FIG. 5) are arrayed on the nozzle face of the inkjet line-heads 64, over a length that exceeds at least the length of one side of the maximum size of paper (the entire width of the image formable range).

The processing liquid possesses the ability to aggregate in the processing liquid colorant (pigments) and latex particles that were dispersed in the ink, and aggregated bodies are formed on the paper, without color-run or the like occurring. As an example of a reaction between the ink and the processing liquid, acid may be contained in the processing liquid, the pigment dispersion broken down by reducing the pH, and the pigment aggregated. Such a mechanism may be employed in order to avoid color bleeding, mixing of each of the colors between the inks, and ejected droplet interference due to liquid merging when ink droplets impact.

By performing droplet ejection synchronized to an encoder (not shown in the drawings), disposed on the image forming drum 36 and detecting rotation speed, the inkjet line-heads 64 are able to determine the impact position of droplets with high precision, and are also capable of reducing ejected droplet unevenness without being affected by vibrations of the image forming drum 36, the precision of a rotation axis 68, or the drum surface speed.

Note that the head unit 66 may be configured retractable from above the image forming drum 36, with the head unit 66 retracted from above the image forming drum 36 when maintenance operations, such as nozzle face cleaning of the inkjet line-heads 64, removal of congealed ink or the like, are executed.

The paper formed with an image on the recording face is conveyed by rotation of the image forming drum 36 toward an intermediate conveying unit 70 provided between the image forming section 16 and the ink drying section 18, however, since the configuration of the intermediate conveying unit 70 is substantially the same as that of the intermediate conveying section 58, explanation thereof will be omitted.

Ink Drying Section

The ink drying drum 38 (described later) is rotatably provided within the ink drying section 18, and plural heated air nozzles 72 and IR heaters 74 are provided above the ink drying drum 38, in close proximity to the surface of the ink drying section 18.

As an example, a pair of the IR heaters 74 are alternately arrayed parallel to one of the heated air nozzles 72, so as to be disposed one on the upstream side and one on the downstream side of the heated air nozzle 72. As an alternative to this, many of the IR heaters 74 may be disposed at the upstream side, with a lot of heat energy irradiated at the upstream side, raising the temperature of the water content, and many of the heated air nozzles 72 may be disposed at the downstream side to blow away the saturated water vapor.

Here the heated air nozzles 72 are disposed such that the angle of heated air that is blown onto the paper is inclined toward the trailing edge side of the paper. By so doing, the flow of heated air due to the heated air nozzle 72 can be concentrated in one direction, the paper is pressed toward the ink drying drum 38 side, and the state of the paper retained on the surface of the ink drying drum 38 can be maintained.

In the portion of the paper formed with the image, the solvent medium that has been separated by the action of colorant aggregation is dried by the warm air from the heated air nozzles 72 and the IR heaters 74, forming an image layer of a thin film.

While it differs depending on the conveying speed, usually the warm air temperature is set from 50° C. to 70° C., and the temperature of the IR heaters 74 is set from 200° C. to 600° C., so that the ink surface temperature is from 50° C. to 60° C. The evaporated solvent medium is exhausted with the air to outside of the image forming apparatus 10, however the air is recycled. The liquid in this air may be recovered by cooling with a cooler, a radiator, or the like.

The paper with dried image on the recording face thereof is conveyed by rotation of the ink drying drum 38 toward an intermediate conveying section 76, disposed between the ink drying section 18 and the image fixing section 20, however since the configuration of the intermediate conveying unit 76 is substantially the same as that of the intermediate conveying section 58, explanation thereof will be omitted.

Image Fixing Section

The image fixing drum 40 is rotatably provided in the image fixing section 20, and the image fixing section 20 has functionality for heating and pressing the latex particles in the thin-layered image layer that was formed on the ink drying drum 38, fusing the latex particles and immobilizing and fixing to the paper.

A heat roller 78 is disposed above the image fixing drum 40, in close proximity to the surface of the image fixing drum 40. The heat roller 78 incorporates a halogen lamp within a metal pipe of good heat conductivity, such as aluminum or the like, and heat energy is imparted by the heat roller 78 to raise the temperature of the latex to the Tg temperature or greater. By so doing, the latex particles fuse, and when fixing is performed by pressing into the undulations on the paper, it is possible to obtain glossiness by leveling the undulations of the image surface.

A fixing roller 80 is provided at the downstream side of the heat roller 78, with the fixing roller 80 disposed in a pressing state onto the surface of the image fixing drum 40 such that a nip force is obtained between the fixing roller 80 and the image fixing drum 40. Configuration is therefore made with at least one of the surface of the fixing roller 80 or the surface of the image fixing drum 40 having a resilient layer thereon, a configuration having a uniform nip width onto the paper.

The paper fixed with an image on the recording face by the above processes, is conveyed by rotation of the image fixing drum 40 to the side of the discharge section 21, provided at the downstream side of the image fixing section 20.

It should be noted that while explanation has been given in the present exemplary embodiment regarding the image fixing section 20, since it is sufficient for the image formed on the recording face to be dried and fixed by the ink drying section 18, the image fixing section 20 is not necessarily always included.

Explanation will now be given regarding the inkjet line-heads 64, serving as the recording heads according to the first exemplary embodiment of the present invention.

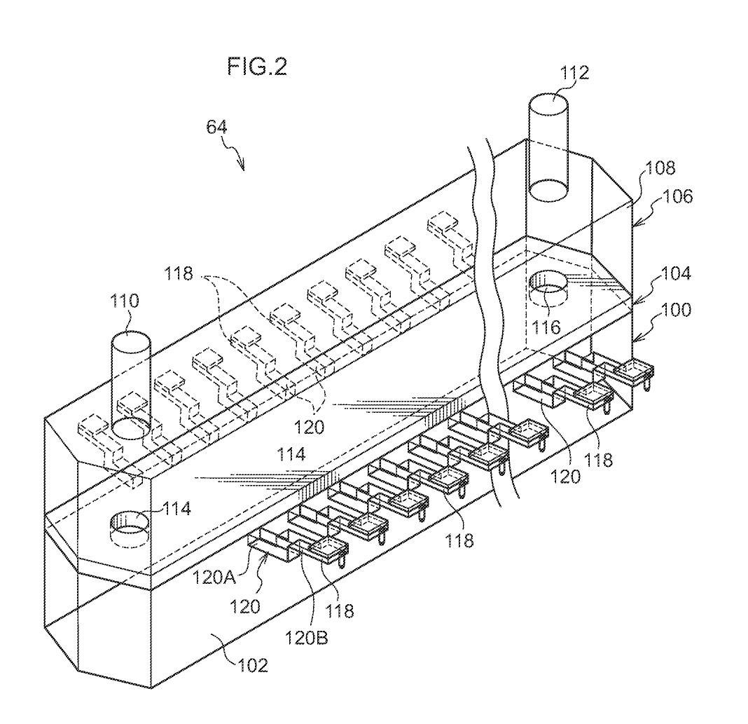

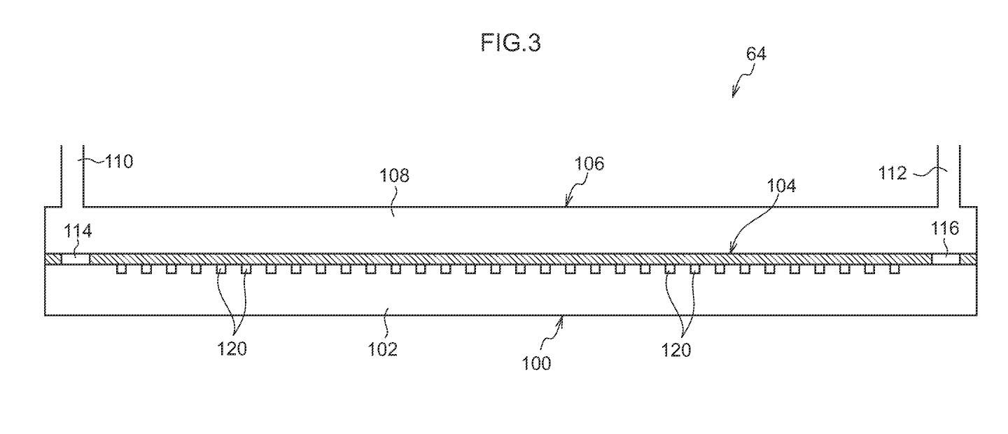

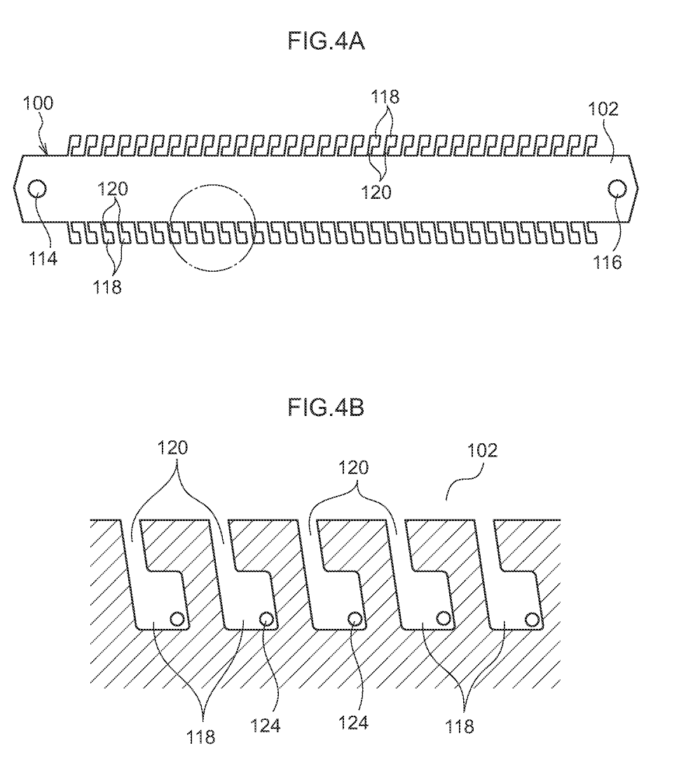

A see-through perspective view of a configuration of the inkjet line-head 64 is shown in FIG. 2. A cross-section of a configuration of the inkjet line-head 64 is shown in FIG. 3. As shown in these drawings, the inkjet line-head 64 is equipped with: a first common path plate 100 formed with a first common path 102 that is of an elongated shape and stores ink; a divider plate 104 joined to the top of the first common path plate 100; and a second common path plate 106 formed with a second common path 108 that is of an elongated shape and stores ink, the second common path 108 being joined to the top of the divider plate 104.

At the top of the second common path plate 106, at the two ends in the length direction thereof, an ink filling inlet 110 for supplying ink into the second common path 108, and an ink discharge outlet 112 for discharging ink from within the second common path 108, are respectively provided. The ink filling inlet 110 is connected to an ink tank (not shown in the drawings) in which ink is stored, and the ink discharge outlet 112 is connected to a discharge tank (not shown in the drawings) that collects ink. There are openings 114 and 116 provided respectively at each of the two ends of the divider plate 104, communicating the first common path 102 with the second common path 108.

Ink in the ink tank (not shown in the drawings) is supplied from the ink filling inlet 110 into the second common path 108. The ink in the second common path 108 is supplied to the first common path 102 via the opening 114, and the ink that has flowed along the length direction in the first common path 102 is supplied to the second common path 108 through the opening 116, and the ink flows along the length direction within the second common path 108. By so doing, the ink circulates between the first common path 102 and the second common path 108. The ink in the second common path 108 is discharged from the ink discharge outlet 112 into the discharge tank (not shown in the drawings).

The first common path 102 and the second common path 108 are formed of substantially the same length in the height direction, length in the length direction, and length in the width direction. Since the first common path 102 and the second common path 108 are disposed one above the other with the divider plate 104 therebetween, there is good placement efficiency, and the length in the length direction is set longer than the maximum width of the paper in order to realize a single-pass configuration.

At both sides along the length direction of the first common path plate 100, as shown in FIG. 2 and FIG. 5, are provided first pressure chambers 118 and plural first ink supply paths 120, serving as first liquid supply paths and respectively communicating with the first pressure chambers 118. The first ink supply paths 120 are formed in substantially an L-shape in a cross-section orthogonal to the length direction of the first common path 102 (a cross-section along the length direction of the first ink supply paths 120). A first end 120A of the first ink supply paths 120 is in communication with the top portion of the first common path 102. The first end 120A of the first ink supply paths 120 is disposed in a direction that is slightly inclined relative to the side wall face of the length direction of the first common path 102.

A second end 120B of the first ink supply paths 120 bends upwards and is in communication with the first pressure chambers 118. The plural first ink supply paths 120 extend out substantially parallel from the side walls of the first common path 102 (see FIG. 3). As they do so, the plural first ink supply paths 120 disposed on one side of the first common path 102 and the plural first ink supply paths 120 disposed on the other side of the first common path 102, are connected at positions in the length direction of the first common path 102 that do not align with each other. By so doing, the plural first pressure chambers 118 can be efficiently placed at position in the length direction that are staggered from each other. The ink in the first common path 102 is distributed to each of the first pressure chambers 118 through the respective first ink supply paths 120.

The first pressure chambers 118 are of a substantially square shaped plan form, with one of a pair of diametrically opposed corners thereof connected to the first ink supply paths 120 and the other of the pair in communication with the nozzles 122 through the flow outlets 124 provided. Note that the shape of the first pressure chambers 118 is not limited to the present example, with various figurations possible therefor, including plan forms of quadrangles (diamonds, rectangles or the like), pentagons, hexagons, other multi angled shapes, circular shapes, elliptical shapes or the like.

A first driving device 126 is provided, serving as a first driving section, to the top of each of the first pressure chambers 118. The first driving device 126 is equipped with a pressurizing plate (vibration plate that is also used as a common electrode) 128 configuring the top face of the first pressure chamber 118, a piezoelectric body 130 provided above the pressurizing plate 128, and an individual electrode 132 provided on the top face of the piezoelectric body 130. The piezoelectric body 130 deforms by application of a driving voltage between the individual electrode 132 and the common electrode, the volume of the first pressure chamber 118 changes, and ink is ejected from the nozzle 122 by an accompanying change in pressure. After ink has been ejected, new ink is refilled into the first pressure chamber 118, from the first common path 102 through the first ink supply path 120, when the displacement of the piezoelectric body 130 returns to its original position.

Plural first pressure chambers 118 are disposed arrayed in a direction orthogonal to the length direction of the first common path 102 and the second common path 108, provided respectively at the edge portions at both sides along the length direction of the first common path 102, with first ink supply paths 120 between the first common path 102 and the first pressure chambers 118. A structure is thereby achieved with the plural first pressure chamber 118 disposed in a matrix shape, corresponding to each of the respective nozzles.

Explanation will now be given of the operation and effect of the inkjet line-head 64.

The second common path 108 is disposed along the length direction of the first common path 102, and the openings 114 and 116 are provided at each of the two ends of the divider plate 104 that is disposed between the second common path 108 and the first common path 102. The ink supplied from the ink filling inlet 110 into the second common path 108 is supplied to the first common path 102 via the opening 114, the ink that has flowed in the length direction in the first common path 102 is supplied to the second common path 108 through the opening 116. Furthermore, this ink flows in the length direction in the second common path 108, and is supplied into the first common path 102 via the opening 114. By so doing, the ink is circulated between the first common path 102 and the second common path 108.

In the inkjet line-head 64 such as this, the overall length of the common path is made longer by providing the second common path 108 superimposed on the first common path 102, and the path for ink circulation is longer. In the present exemplary embodiment, since the first common path 102 and the second common path 108 have substantially the same dimensions, the overall length of the common path for storing the ink becomes twice that were only the first common path 102 to be provided. By so doing, since the resonance frequency of ink in the first common path 102 and the second common path 108 is lowered, the effective resonance frequency can be moved away from the ejection frequency band. For example, if the resonance frequency and the ejection frequency band were to overlap in a configuration in which only the first common path 102 is provided, the resonance frequency can be made smaller than the ejection frequency band. Therefore, the influence of cross-talk due to low frequency resonance can be suppressed. At the same time, since the path through which the ink circulates is longer by provision of the first common path 102 and the second common path 108, the size of cross-talk due to viscosity attenuation can be attenuated to about ½. In the present exemplary embodiment, for example, when the ejection frequency is about 25 kHz, the resonance frequency can be lowered to about 12.5 kHz.

Furthermore, by disposing the second common path 108 above the first common path 102, with the divider plate 104 interposed therebetween, and by communicating the two ends of the first common path 102 and the second common path 108, the first common path 102 and the second common path 108 can be placed with good efficiency, and a reduction in space is enabled. By circulating the ink between the first common path 102 and the second common path 108, ink can be prevented, or suppressed, from dwelling in the first common path 102 and in the second common path 108.

### Second Exemplary Embodiment

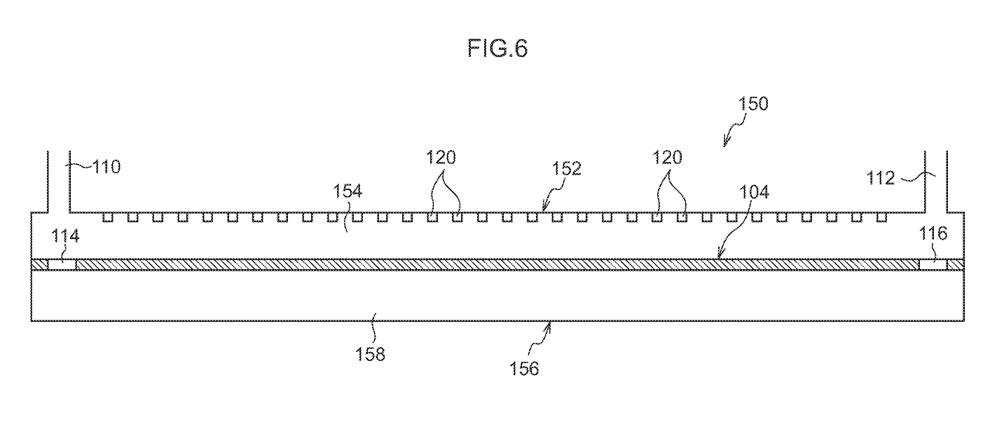

Explanation will now be given of an inkjet line-head as a recording head according to a second exemplary embodiment of the present invention, with reference to FIG. 6. Note that portions of the configuration that are similar to those of the previously described first exemplary embodiment are allocated the same reference numerals, and explanation thereof is omitted.

As shown in FIG. 6, the inkjet line-head 150 is equipped with: a first common plate 152 formed with an elongated shaped first common path 154 for storing ink; a divider plate 104 joined to the bottom of the first common plate 152; and a second common plate 156 joined to the bottom of the divider plate 104 and formed with an elongated shaped second common path 158. The openings 114, 116 are also provided at the respective two ends of the divider plate 104, communicating the first common path 154 and the second common path 158, and ink is circulated between the first common path 154 and the second common path 158.

Plural ink supply paths 120 are provided at an upper portion of the first common path 154 at both sides along the length direction of the first common plate 152, respectively communicating with the first pressure chambers 118 (see FIG. 2). The first common path 154 and the second common path 158 are formed with substantially the same length in the height direction, length in the length direction, and length in the width direction.

In such an inkjet line-head 150, by providing the first common path 154 superimposed on the second common path 158, the overall length of the common path is made longer, and the path through which the ink circulates is made longer. In the present exemplary embodiment, since the first common path 154 and the second common path 158 have substantially the same dimensions, the overall length of the common path for storing the ink becomes twice as long. By so doing, since the resonance frequency of ink in the first common path 154 and the second common path 158 is lowered, the effective resonance frequency can be moved away from the ejection frequency band, and the influence of cross-talk due to low frequency resonance can be suppressed. At the same time, since the path the ink circulates in is longer by provision of the first common path 154 and the second common path 158, the size of cross-talk can be attenuated to about ½ by viscosity attenuation.

### Variations on the First Exemplary Embodiment and the Second Exemplary Embodiment

The inkjet line-head 64 of the first exemplary embodiment is a two layer structure, provided with the first common path 102 and the second common path 108, and the inkjet line-head 150 of the second exemplary embodiment is a two layer structure, provided with the first common path 154 and the second common path 158, however, configuration may be made with a multi-layered structure, with one or plural common paths provided as well as the second common path (a configuration with 3 layers or more of common paths in total). In such a configuration, the dimensions, such as thickness and the like, of the respective common paths are preferably adjusted such that the ease with which ink flows in each of the respective 3 or more layers of common path is the same. In such a configuration, since the overall common path for storing the ink becomes longer, the effective resonance frequency can be moved away from the ejection frequency band, and influence of cross-talk due to low frequency resonance can be suppressed.

In the first exemplary embodiment and the second exemplary embodiment, configuration is made with the ink circulating through the two end portions of the first common path and the second common path, however there is no limitation thereto. Configuration may be made with the first common path and the second common path in communication with each other at a single location, with ink supplied from one common path to the other common path therethrough.

What is claimed is:

1. A recording head comprising:
a plurality of pressure chambers that are filled with a liquid and are in communication with nozzles that eject liquid droplets toward a recording medium;
a driving section that changes pressure in the pressure chamber and ejects a liquid droplet from the nozzle;
a first common path that is connected to a plurality of liquid supply paths that are in communication with the respective pressure chambers, the first common path storing the liquid for supply to the pressure chambers;
a second common path that is superimposed on the first common path, is in communication with the first common path, and stores the liquid.

2. The recording head of claim 1 further comprising a divider plate that divides the first common path from the second common path, and wherein the liquid is circulated between the first common path and the second common path through openings formed in respective two ends of the divider plate.

3. The recording head of claim 2, configured with a multi-layer structure further comprising one or a plurality of common paths as well as the second common path.

4. An image forming apparatus that forms an image by passing a recording medium through a position facing a recording head, the image forming apparatus comprising:
the recording head of claim 1; and
a conveying section that conveys a recording medium to a position facing the recording head.

5. The recording head of claim 1, wherein the first common path and the second common path are formed of substantially the same length in the height direction, length in the length direction, and length in the width direction.

6. The recording head of claim 1, wherein the first common path and the second common path are disposed one above the other with the divider plate therebetween, and the length in the length direction is set longer than the maximum width of the paper.

7. The recording head of claim 1, wherein the first ink supply paths are formed in substantially an L-shape in a cross-section orthogonal to the length direction of the first common path, and a first end of the first ink supply paths is in communication with the top portion of the first common path.

8. The recording head of claim 1, wherein the first end of the first ink supply paths is disposed in a direction that is inclined relative to the side wall face of the length direction of the first common path.

9. The recording head of claim 1, wherein the plural first ink supply paths disposed on one side of the first common path and the plural first ink supply paths disposed on the other side of the first common path, are connected at positions in the length direction of the first common path that do not align with each other.
